(19) United States
(12) Patent Application Publication
(10) Pub. No.: US 2009/0294218 A1
(43) Pub. Date: Dec. 3, 2009

(54) BOMB DISPOSAL ROBOT HAVING A FORKLIFT CAPABILITY AND METHOD

(76) Inventors: Geoffrey Archer, Las Vegas, NV (US); Tim Ignatiuk, Las Vegas, NV (US)

Correspondence Address: WEISS & MOY PC, 4204 NORTH BROWN AVENUE, SCOTTSDALE, AZ, 85251, US

(21) Appl. No.: 12/127,068

(22) Filed: May 27, 2008

(51) Int. Cl. B66F 9/12; B65H 1/00

(52) U.S. Cl. 187/237; 414/806; 901/1

(57) ABSTRACT

A forklift assembly is mounted to a robotic bomb disposal vehicle. The forklift assembly includes at least one fork, and may be coupled via a receiver hitch to the vehicle. In one embodiment, the receiver hitch is positioned between articulating arms located on the vehicle, permitting vertical movement of the forks. An explosive countermeasure is positioned on the forks. With the countermeasure so positioned, the vehicle may be caused to travel proximate a vehicle suspected of having an explosive device therein. The countermeasure may then be lowered onto the ground at a desired position proximate the suspect vehicle, and the robotic bomb disposal vehicle withdrawn from the site.

### FIELD OF THE INVENTION

The present invention relates to bomb disposal apparatuses and methods and, more particularly, to an improved bomb disposal robot having a forklift capability and method for utilizing such a robot.

### BACKGROUND OF THE INVENTION

Vehicle-borne IED's (VBIED's) and large vehicle-borne IED's (LVBIED's) are certainly generating a high level of concern for those involved in anti-terror and bomb-disposal efforts. Whether large or small, car bombs present a significant threat and a major challenge with respect to suitable render safe procedures and the safety, speed and accuracy with which they may be performed. Rapid and reliable deployment is critical.

A conventional method of dealing with a suspected VBIED or LVBIED is through the use of an explosive countermeasure, placed under or sometimes along the side of the suspect vehicle. Examples of commonly-used vehicle countermeasures include Bootbanger, MLVD, AquaRam, Trunk Trasher, and Big Mike.

Bomb disposal experts make use of robotic vehicles, such as the Remotec F6A manufactured by Northrop Grumman, for a variety of tasks related to bomb disposal. The F6A travels on four wheels, and also includes two sets of articulating tracks, one set projecting to the front and one set to the rear, which permit the vehicle to traverse ditches and other obstacles. However, the F6A does not have the capacity to grasp, transport or position countermeasures for a VBIED or LVBIED. That requires a manual approach to the suspect vehicle, where the charge is either positioned under or near the vehicle by a person or is left near the vehicle, before being nudged into position by a remote vehicle. These methods are relatively dangerous, slow and potentially unreliable.

### SUMMARY OF THE INVENTION

In accordance with an embodiment of the present invention, a forklift assembly mountable to a bomb disposal robot is disclosed. The assembly comprises, in combination: at least one fork; wherein the at least one fork is mounted to a support bar; a tongue coupled to the support bar and extending in a direction opposite to that of the at least one fork; wherein the tongue is adapted to be inserted into a receiver hitch mounted on a robotic bomb disposal vehicle.

In accordance with another embodiment of the present invention, a robotic bomb disposal vehicle having a forklift is disclosed. The vehicle comprises, in combination: a robotic bomb disposal vehicle; a receiver hitch mounted on the robotic bomb disposal vehicle; at least one fork; wherein the at least one fork is mounted to a support bar; wherein the at least one fork is capable of supporting thereon at least one explosive countermeasure; and a tongue coupled to the support bar and extending in a direction opposite to that of the at least one fork; wherein the tongue is adapted to be inserted into the receiver hitch.

In accordance with a further embodiment of the present invention, a method for delivering an explosive countermeasure to a vehicle suspected of having an explosive device therein is disclosed. The method comprises: providing a robotic bomb disposal vehicle having a receiver hitch mounted thereon; positioning a forklift assembly on the receiver hitch; wherein the forklift assembly comprises: at least one fork; wherein the at least one fork is mounted to a support bar; wherein the at least one fork is capable of supporting thereon at least one explosive countermeasure; and a tongue coupled to the support bar and extending in a direction opposite to that of the at least one fork; wherein the tongue is adapted to be inserted into the receiver hitch; positioning an explosive countermeasure on the at least one fork; causing the robotic bomb disposal vehicle to transport the explosive countermeasure to a desired position proximate a suspect vehicle; depositing the explosive countermeasure on a ground surface below the suspect v vehicle; and withdrawing the robotic bomb disposal vehicle, without the explosive countermeasure thereon, from the suspect vehicle.

### BRIEF DESCRIPTION OF THE DRAWINGS

FIG. 1 is a top view of a forklift assembly portion capable of being mounted to a receiver hitch on a bomb disposal robot, consistent with an embodiment of the present invention.

FIG. 2 is a side view of the forklift assembly of FIG. 1.

FIG. 3 is a top view illustrating mounting of the forklift assembly of FIGS. 1-2 to a bomb disposal robot.

FIG. 4 is a side view illustrating mounting of the forklift assembly of FIGS. 1-2 to a bomb disposal robot.

FIG. 5 is a side view illustrating placement of a countermeasure on a forklift assembly mounted to a bomb disposal robot.

FIG. 6 is a side view illustrating placement of a countermeasure below a vehicle utilizing a bomb disposal robot having a forklift assembly mounted thereon.

### DETAILED DESCRIPTION OF THE PREFERRED EMBODIMENTS

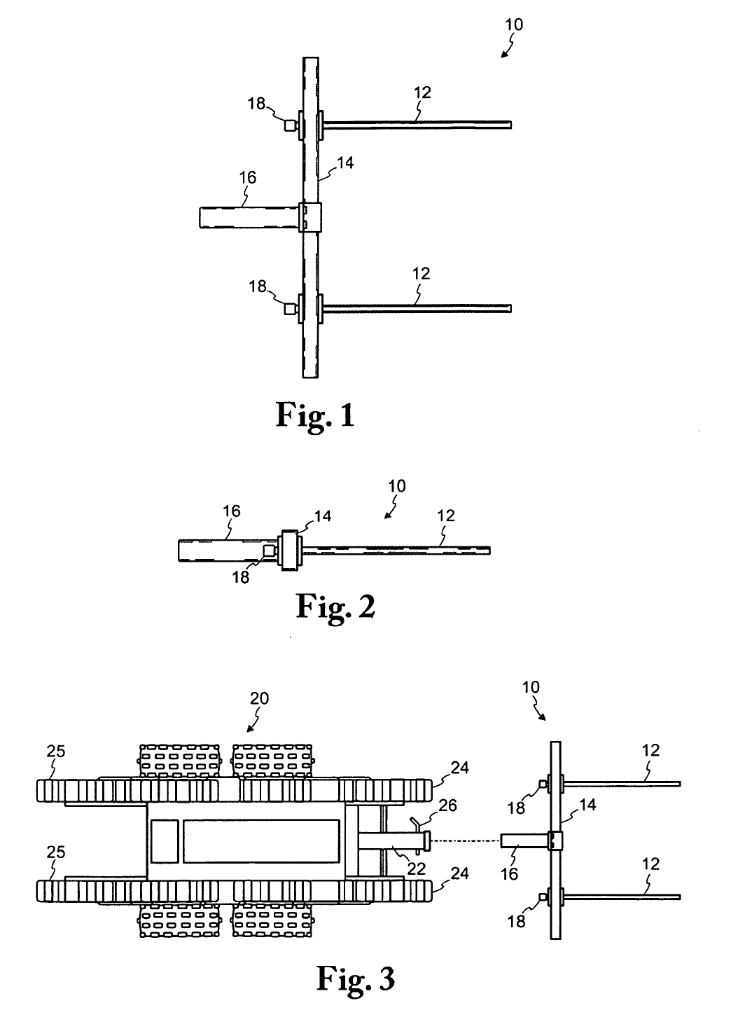

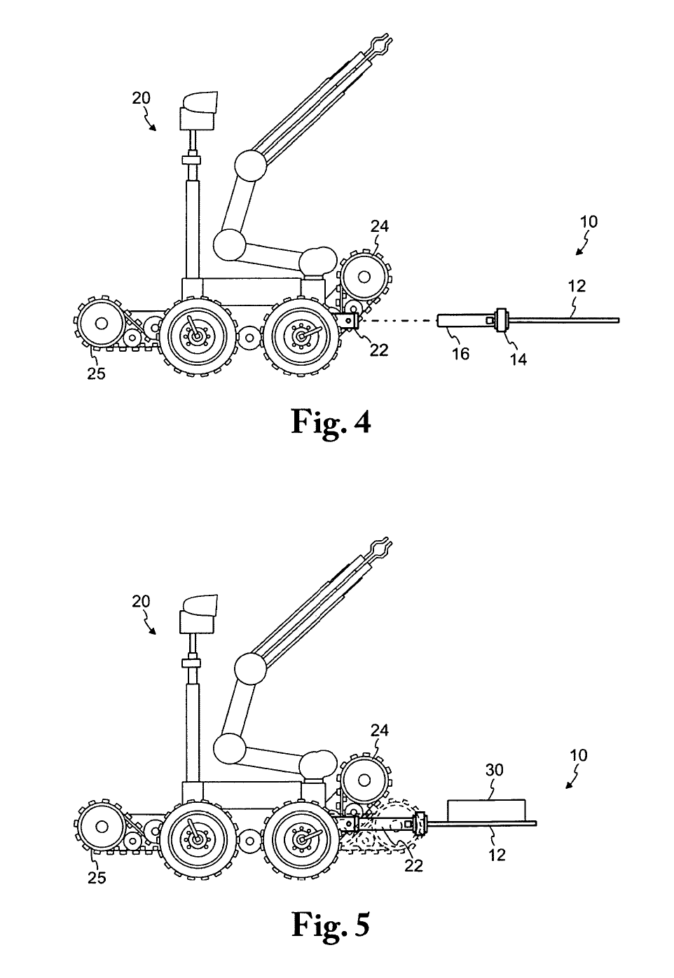

Referring first to FIGS. 1-2, a forklift assembly 10 consistent with an embodiment of the present invention is shown. In this embodiment, the forklift assembly 10 comprises two forks 12 mounted to a support bar 14. In this embodiment, a tongue 16 is positioned along the support bar 14, and is dimensioned to be inserted into a receiver hitch, as discussed below.

In one embodiment, positioning of the forks 12 along the support bar 14 is adjustable and, indeed, the forks 12 may be entirely removable from the support bar 14. This may be accomplished in a variety of ways, including by way of example only utilizing spring-loaded insertion pin 18 that may be inserted into a suitable opening (not shown) along a length of the support bar 14. The forks 12 could be flat, round, hexagonal, or in some other desired shape. It may also be desired to use only a single fork 12, or perhaps more than two forks 12.

Reference is now made to FIGS. 34. The forklift assembly 10 may be mounted to a bomb disposal robot 20 by first affixing to the bomb disposal robot 20 a receiver hitch 22. (The robot 20 may be, for example, a Remotec F6A manufactured by Northrop Grumman, though the present invention may be utilized with other robotic platforms as well.) Preferably, as illustrated in FIG. 3, the receiver hitch 22 is affixed between articulating arms 24 on the robot 20, in such fashion so as not to interfere with the operation of the arms 24. (While a mounting between the front articulating arms 24 is shown, mounting between rear articulating arms 25 would also be possible.) The tongue 16 may then be inserted into the receiver hitch 22, and secured in a position with, for example, a pin 26 extending through aligned openings in the tongue 16 and receiver hitch 22.

### Statement of Operation

Referring first to FIGS. 1-3, as described above, the forklift assembly 10 is first positioned on a robot 20, by insertion of the tongue 16 into the receiver hitch 22. The forklift assembly 10 may be secured in position by insertion of the pin 26 through the tongue 16 and the receiver hitch 22. If the forklift assembly 10 utilizes adjustable forks 12, these may be spaced as desired.

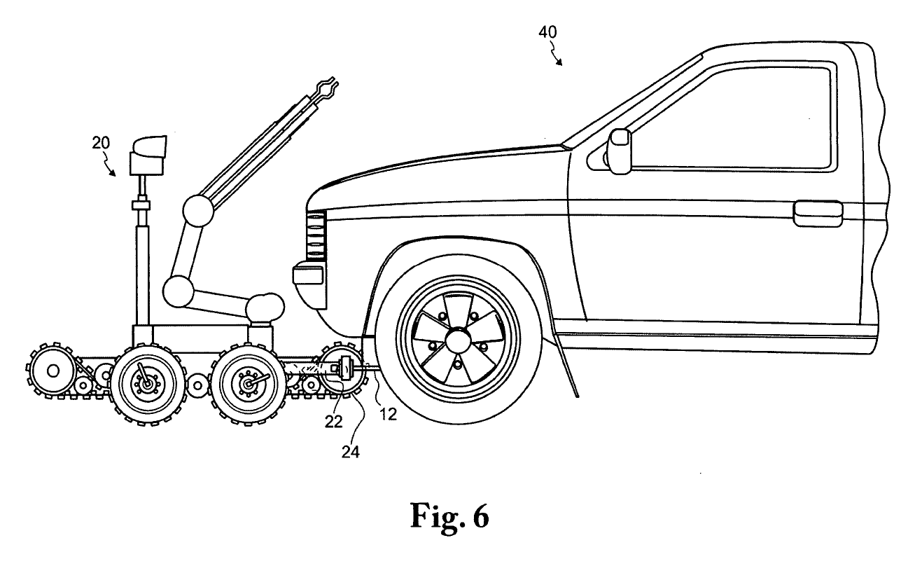

Referring now to FIGS. 5-6, for use with a suspected VBIED or LVBIED, an explosive countermeasure 30 is positioned on the forks 12 of the forklift assembly 10, with the forklift assembly 10 being mounted to a robot 20 as discussed above. The arms 24 should be positioned so that the forks 20 are at a desired height, which typically will be in a relatively horizontal orientation above the ground, as shown in FIG. 5.

In this configuration, the robot 20 may then be sent in the direction of the suspect vehicle 40 having an IED therein. The robot 20 may be brought into sufficient proximity to the vehicle 40 to permit the countermeasure 30 to be placed thereunder at a desired location. It may be necessary, in order for the countermeasure 30 to pass underneath the vehicle 40, to lower the forks 12 by downward movement of the articulating arms 24. When the countermeasure 30 is in the desired position, the articulating arms 24 are moved downward until a front portion of the forks 12 touch the ground and the countermeasure 30 is able to slide off of the forks 12 and onto the ground below the vehicle 40. The robot 20 may then be backed up, and withdrawn from the location, leaving the countermeasure 30 in position.

An advantage of the configuration described herein is that it permits the forklift assembly to be positioned on the robot 20 when needed, and removed when not needed, so as to not interfere with other uses of the robot 20. However, it may be desired to provide a robot 20 having a forklift assembly 10 more permanently affixed thereto. In such a configuration, the tongue 16/receiver hitch 22 combination would not be needed. Moreover, while vertical movement of the forklift assembly 10 may, in one embodiment, be accomplished by movement of the articulating arms 24, it should be noted that a different lifting/lowering means may be utilized.

Although particular embodiments of the invention have been described in detail for purposes of illustration, various modifications may be made without departing from the spirit and scope of the invention. Accordingly, the invention is not to be limited, except as by the appended claims.

We claim:

1. A forklift assembly mountable to a bomb disposal robot comprising, in combination:
at least one fork;
wherein the at least one fork is mounted to a support bar;
a tongue coupled to the support bar and extending in a direction opposite to that of the at least one fork;
wherein the tongue is adapted to be inserted into a receiver hitch mounted on a robotic bomb disposal vehicle.

2. The forklift assembly of claim 1 having two forks and wherein a position of the two forks along the support bar is adjustable.

3. A robotic bomb disposal vehicle having a forklift comprising, in combination: combination:
a robotic bomb disposal vehicle;
a receiver hitch mounted on the robotic bomb disposal vehicle;
at least one fork;
wherein the at least one fork is mounted to a support bar;
wherein the at least one fork is capable of supporting thereon at least one explosive countermeasure; and
a tongue coupled to the support bar and extending in a direction opposite to that of the at least one fork;
wherein the tongue is adapted to be inserted into the receiver hitch.

4. The robotic bomb disposal vehicle of claim 3 wherein the receiver hitch is mounted between articulating arms located on the robotic bomb disposal vehicle.

5. The robotic bomb disposal vehicle of claim 4 having two forks and wherein a position of the two forks along the support bar is adjustable.

6. The robotic bomb disposal vehicle of claim 3 wherein the forks are capable of being raised or lowered while in position on the robotic bomb disposal vehicle and with an explosive countermeasure located thereon.

7. A method for delivering an explosive countermeasure to a vehicle suspected of having an explosive device therein comprising:
providing a robotic bomb disposal vehicle having a receiver hitch mounted thereon;
positioning a forklift assembly on the receiver hitch;
wherein the forklift assembly comprises:
at least one fork;
wherein the at least one fork is mounted to a support bar;
wherein the at least one fork is capable of supporting thereon at least one explosive countermeasure; and
a tongue coupled to the support bar and extending in a direction opposite to that of the at least one fork;
wherein the tongue is adapted to be inserted into the receiver hitch;
positioning an explosive countermeasure on the at least one fork;
causing the robotic bomb disposal vehicle to transport the explosive countermeasure to a desired position proximate a suspect vehicle;
depositing the explosive countermeasure on a ground surface below the suspect v vehicle; and
withdrawing the robotic bomb disposal vehicle, without the explosive countermeasure thereon, from the suspect vehicle.

8. The method of claim 7 wherein the receiver hitch is mounted between articulating arms located on the robotic bomb disposal vehicle.

9. The robotic bomb disposal vehicle of claim 7 having two forks and wherein a position of the two forks along the support bar is adjustable.
